(19) United States
(12) Patent Application Publication
(10) Pub. No.: US 2006/0046232 A1
(43) Pub. Date: Mar. 2, 2006

(54) Methods for acquiring language skills by mimicking natural environment learning

(76) Inventor: Eran Peter, Kfar Sava (IL)

Correspondence Address: DR. MARK FRIEDMAN LTD.;C/o Bill Polkinghorn, 9003 Florin Way, Upper Marlboro, MD, 20772, US

(21) Appl. No.: 11/217,594

(22) Filed: Sep. 2, 2005

Related U.S. Application Data
(60) Provisional application No. 60/606,423, filed on Sep. 2, 2004.

(51) Int. Cl. G09B 19/04

(52) U.S. Cl. 434/185

(57) ABSTRACT

A method for live-learning language skills comprises the steps of providing, in a live-learning environment, at least one visual display operative to display images correlated with corresponding sounds to a non-static user positioned in a line-of-sight from the display and enabling the user to view each image in close temporal proximity to hearing its corresponding sound. In a particularly preferred embodiment, the method provides a live-learning environment full of clues that help decode the images, thereby mimicking the natural language acquisition of humans.

### CROSS REFERENCE TO RELATED APPLICATIONS

The present application claims the benefit of priority from U.S. Provisional Patent Application No. 60/606,423 filed Sep. 2, 2004, the contents of which are incorporated herein by reference.

### FIELD OF THE INVENTION

The present invention relates generally to learning methods, and in particular to methods for language skills acquisition in an environment that mimics the natural learning environment.

### BACKGROUND OF THE INVENTION

Language, and specifically the written word, is one of the things that separate man from other living species. The ability to understand speech is natural. Reading on the other hand is not a natural ability. For example, almost 15% of the U.S. population suffers from some kind of reading disorder.

Reading is a logical activity which one (e.g. a child) performs in his/her own imagination, thus, there is very little external information from which a child may learn from in order to understand that strange graphical symbols form words that can be pronounced and understood.

Reading instruction is typically begun with the informal exposure of pre-school children to printed material and individual letters. Formal instruction is usually not undertaken until school entry following the child's fifth or sixth birthday, and reading proficiency is developed over the next several years.

There are two major schools of thought regarding reading teaching: “phonics”, which emphasizes letters, words, and the correspondence of graphemes (written or printed patterns) to phonemes (sounds of the spoken language) and “whole language”, which emphasizes the natural reading experience. In both, the main emphasis is on formal instruction during school years, with preschool years seen as useful only for foundational activities such as print awareness and letter naming, with infancy seen as irrelevant.

Dyslexia is characterized by difficulty in reading, and is diagnosed more specifically by the presence of a subset of a list of specific reading-related performance problems. However, there is little agreement on the causes or cures of dyslexia, and even the condition itself defies unambiguous characterization. Recent research has shown dyslexia to be associated with unusually low levels of activity in the left inferior parietal area of the brain.

In the political arena, much energy is expended on championing methods of instruction that embody either the “phonics” or “whole language” methods. The rationale is that an un-favored method is responsible for children's difficulties in reading, and a favored method would solve all problems. In the academic arena, most efforts go into dissecting the act of reading into its presumed component parts or sub-skills. These include the alphabet principle, phonemic awareness, and the development of a mental lexicon. Difficulty in the learning and practice of reading are thought to be the result of deficient mastery of one or more sub-skills, such as eye-tracking across a line of print. Controversy surrounds the mechanism and timing of acquisition of the purported sub-skills. Also unsettled is the exact relationship between these sub-skills and ultimate success in skillful reading.

An extensive literature exists on all these topics, but despite the clear need, no single remedial program has shown itself to be so successful as to be universally accepted. Dyslexia specifically, and poor reading skills in general, have been shown to persist into adulthood and to have a negative impact on quality of life. Several programs, such as that called “reading recovery” in New Zealand, attempt to rectify the failures of school reading instruction. Such programs have shown some successes, but the results are neither as clear nor as cost-effective as to have produced general acceptance and use.

Various methods and systems for the purpose of acquisition of speech, reading and writing skills are known in prior art. In particular, U.S. Pat. No. 5,717,828 discloses a speech recognition apparatus and method for learning that extends the capability of conventional computer speech recognition programs to reliably recognize and understand large word and phrase vocabularies for teaching language comprehension and oral production skills. At each step of a teaching program, information is supplied to the user such that some responses in the language being taught are correct (or appropriate) and some are incorrect (or inappropriate), with these respective sets of responses judiciously selected to teach some language aspect. A subset of allowable correct and incorrect responses is selected such that a speech recognition subprogram readily discerns certain allowable responses from other allowable responses, including each incorrect response being discriminable from each correct response. The meanings of at least the correct allowable responses are made clear by aural or visual information, such as graphic images, printed text, or translations into the user's native language. A model of the correct pronunciation of each allowable response may be available, with these models presented either exhaustively or selectively. The invention includes a mechanism for differentiating between improperly formed and deficient productions and providing corrective feedback upon deficient production. The mechanism for differentiating may include dummy, improperly formed speech models, and augmentative voice analyzers may be used. Augmentative monitors capturing non-acoustic measurements may be included.

A major disadvantage of U.S. Pat. No. 5,717,828 is that it does not provide a teaching method that mimics the natural language learning, in which the subject being taught is made available at all times to the learner. Another disadvantage is that the method assumes earlier reading and language background, i.e. one must know how to read in order to use this method.

U.S. Patent Application No. 20050142522 to Kullock et al. discloses a system for treating disabilities such as dyslexia by enhancing holistic speech perception. A subject listens to a sound stimulus which induces the perception of verbal transformations. The subject records the verbal transformations, which are then used to create further sound stimuli in the form of semantic-like phrases and an imaginary story. Exposure to the sound stimuli enhances holistic speech perception of the subject with cross-modal benefits to speech production, reading and writing. The present invention has application to a wide range of impairments including, Specific Language Impairment, language learning disabilities, dyslexia, autism, dementia and Alzheimer's.

A main disadvantage of Kullock's application is that the material being taught is either decided in advance or it is not taught as a “live” translation of normal speech. That is, there is no “live” teaching. Its main purpose is in helping in utterance of words and sentences by using “help”. Another disadvantage is that, as above, it requires active study, therefore being limited in practice time.

U.S. Patent Application No. 20020164563 to Wasowicz et al. discloses a diagnostic system and method for phonological awareness, phonological processing, and reading skill testing. The object of this invention is to create a diagnostic system, not a teaching method. The diagnostic system and method can evaluate one or more phonological awareness, phonological processing and reading skills of an individual to detect phonological awareness, phonological processing and reading skill deficiencies in the individual so that the risk of developing a reading deficiency is reduced and existing reading deficiencies are remedied. The system may use graphical games to test the individual's ability in a plurality of different phonological awareness, phonological processing and reading skills. The system may use speech recognition technology to interact with the games. The system may include a module for providing motivation to a user of the system being tested. Here too, there is no “live teaching” and the material to be taught is either decided in advance, or is not provided as a live translation of normal speech.

U.S. Pat. No. 6,629,844 to Jenkins et al. discloses a method and apparatus for training of cognitive and memory systems in humans The apparatus and method incorporate a number of different programs to be played by the subject. The programs artificially process selected portions of language elements, called phonemes, so they will be more easily distinguished by the subject, and gradually improves the subject's neurological processing and memory of the elements through repetitive stimulation. The programs continually monitor a subject's ability to distinguish the processed language elements, and adaptively configures the programs to challenge and reward the subject by altering the degree of processing. Through adaptive control and repetition of processed speech elements, and presentation of the speech elements in a creative fashion, a subject's cognitive processing of acoustic events common to speech, and memory of language constructs associated with speech elements are significantly improved. This invention does not deal with live-learning, in that the learner is not provided with constant means to correlate visual information with corresponding sound.

U.S. Patent Application No. 20020115044 to Shpiro discloses a system that provides language instruction through oral production of phrases by a user. The instruction is done by receiving a spoken input from the user and recognizing the spoken input as being one of multiple permitted input phrases having a predetermined meaning, and analyzing the spoken input so as to identify a departure of the spoken input from a desired oral production of the permitted input phrase. A system response to the spoken input may be implemented in accordance with the predetermined meaning of the permitted input phrase. The system response may be implemented according to the phrases that the system knows the user was trying to say, even while the system recognizes the departure of what the user said from the input phrase the user was attempting to say.

All prior art methods of teaching language, reading or writing skills do so either “statically” or “periodically”. “Statically” means that at least one of the learner or the visual display is static. Exemplarily, a child may sit in front of a static visual display and simultaneously hear a sound correlated with an image. “Periodic” implies a temporal non-constant learning activity: the child may perform the learning for a given time period, stop and move away from the static visual display, in which case even if sound and images continue to be provided, the child hears the sound but does not see the corresponding image. None of these resemble the natural language learning environment.

There is therefore a widely recognized need for, and it would be highly advantageous to have methods for reading acquisition, writing acquisition and speech learning and training that are “live”, mimic the natural learning environment and which do not suffer from the abovementioned disadvantages. More specifically, it would be advantageous to have methods and systems capable of displaying text in a linear way, displaying text related to the environment and to a learner's activity, and displaying text corresponding to sounds being heard by the learner in order to link between each sound and its related graphical symbol, all of this done in conjunction with a natural learning environment.

### SUMMARY OF THE INVENTION

The present invention discloses, in various embodiments methods and systems for language skills acquisition in an environment that mimics the natural learning environment. Language skills include speech, reading and writing. Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

The basic assumption used herein is that there is one-to-one correspondence between two forms of language, oral speech and written text. In the context of the present invention, “text” (written language) may represent sentences, words, phonemes, graphemes and syllables. Displayed text, objects and graphical symbols are referred to herein as “images”. Thus, displayed sentences, words, phonemes or syllables are all referred to as images. The main tool one uses in decoding speech is the listening to the natural speaking environment, which surrounds him/her. This main tool provides the user with clues. For example, a mother holding a bottle and saying “this is a bottle” helps a child link between the pronunciations of the word “bottle” and the physical object.

Since the understanding of speech is a byproduct of the natural environment of a child, one object of the invention is to establish the existence of an induced, “live-learning” environment that mimics the natural environment and that provides the child with the ability to read as a byproduct of this environment. For example, the holding of the bottle by the mother and the sounding of its description may be replaced by the display (on a screen worn by the mother) of the object “bottle”, with its description sounded simultaneously. Another object of the invention is to link between a spoken sound and its graphical representation in real-time in a live-learning environment, when the representation needs to be close in time to (in close temporal relation with) the sound. Preferably, the written text is displayed to the learner as much as possible constantly and repeatedly, throughout all normal and usual everyday activities.

The present invention discloses a method and system capable of displaying text in a linear way, displaying text related to the environment and the learner's activity, and of displaying text corresponding to the sounds being heard by the learner in order to link between the sound and its graphical symbol. The method and system enable to “see” speech by providing speech recognition embedded in natural life and living environment.

According to the present invention there is provided a method for live-learning language skills comprising the steps of providing, in a live-learning environment, at least one visual display operative to display images correlated with corresponding sounds to a non-static user positioned in a line-of-sight from the at least one display, and, by the user, viewing each image in close temporal proximity to hearing its corresponding sound.

According to one feature of the present invention, the step of providing includes providing at least one visual display selected from the group consisting of a portable video display, a beamed image, a miniaturized eye-glass video display and a direct eye beamed display.

According to another feature of the present invention, the images include images selected from the group consisting of sentences, words, phonemes, graphemes, syllables and color images.

According to yet another feature of the present invention, the user is a child and the step of providing includes providing a display positioned on a caregiver in the line-of-sight.

According to yet another feature of the present invention, the user is a hearing impaired user pronouncing the corresponding sounds and the step of providing at least one visual display operative to continuously display images correlated with corresponding sounds includes providing images selected from the group consisting of tone, volume and other aspects of sound analysis.

According to the present invention there is provided a method for live-learning language skills comprising the steps of positioning a non-static display and a non-static learner in a relational position that ensures a substantially constant spatial line-of-sight therebetween for extended periods of time; and displaying an image on the display while essentially simultaneously sounding a corresponding sound that defines the image, whereby, the positioning and sounding actions mimic a natural, live-learning environment for the acquisition of language skills.

According to one feature of the present invention, the non-static learner is a child, the language skills include learning a primary language and the step of positioning includes providing a display attached to a caregiver.

According to another feature of the present invention the display is attached to a mother's chest.

According to yet another feature of the present invention, the language skills include reading skills.

According to yet another feature of the present invention, the language skills include writing skills.

According to yet another feature of the present invention, the language skills include at least one secondary language.

According to the present invention there is provided a live-learning system for acquiring language skills comprising a non-static display operative to display images correlated with corresponding sounds provided substantially simultaneously with the images and means to position the display in substantially constant line-of-sigh with a non-static user, whereby the user acquires language skills in an environment that mimics the natural language learning environment.

According to one feature of the present invention, the non-static user is a child learning a primary language and the means to position include a non-static display attached to a caregiver in a way that provides the substantially constant line-of-sight.

According to another feature of the present invention, the system further comprises a detection mechanism operative to activate the display upon detection of the line-of-sight between caregiver and child.

According to another feature of the present invention, the non-static user is a hearing impaired user, and wherein the images are feedback sound images correlated with speech sounds pronounced by the user.

### BRIEF DESCRIPTION OF THE DRAWINGS

For a better understanding of the present invention and to show more clearly how it could be applied, reference will now be made, by way of example only, to the accompanying drawings in which:

FIG. 1 shows schematically a flow chart of the language acquisition method of the present invention;

FIG. 2 shows an exemplary system embodiment in which a child learns his primary language.

### DETAILED DESCRIPTION OF THE PREFERRED EMBODIMENTS

The present invention is of “live-learning” methods and systems for language learning, including (but not limited to) reading acquisition, writing acquisition and speech learning. In contrast with prior art, the combination of sound and images is provided constantly, at all times, in a way that mimics the natural learning environment. Another inventive aspect includes use of a natural environment of the learner combined with speech-to-text, and the blockage of sound combined with speech-to-text presentation.

According to the present invention, speech acquisition is preferably achieved by using real-time speech recognition systems. Whenever a learner hears speech, an automatic translation system turns it into text or some more sophisticated and helpful graphical information. At least one display device is permanently located so as to provide constant, real-time visual inputs of the subject of the speech to the learner. The text or graphical information is displayed to the learner in temporal proximity to the sound of the spoken word or phoneme, thus enabling a “linear” display of the text.

Speech is a stream of data received in a linear form, i.e. syllable after syllable and word after word. It is a very simple task to determine its order. Text on the other hand, is not normally “linear”. Upon looking at a written page, it is not obvious how to even begin to “read” it, i.e. whether to start from right to left, from top to bottom or vice-versa. There are languages ordered in each of the suggestions above. Therefore, in order to mimic the speech-understanding process, written text should be displayed in a linear form. The present invention provides such “linear” text learning.

The present invention also provides a close connection to environment activity and linkage between the spoken language and the written one. A simple example of a “text=sound” learning is pronouncing the phoneme “A” while displaying the phoneme on a visual display device, thus enabling a viewer to link between the sound and its graphical representation. Preferably, the learner and the visual device are positioned relative to each other in a way to make the visual representation available at all times to the learner (constant line-of-sight).

The present invention mimics the natural learning environment of, exemplarily, a child by providing “clues” associated with sound. Clues from the environment are used to understand meaning. A simple example includes correlating between the sound and sight of a bottle in real-time: “a bottle” is being said to a child many times while holding a bottle, so that the child will link the graphical image “bottle” with the bottle itself much like he does with the pronunciation of the word. Alternatively, the bottle may be displayed on a screen (display) worn by the child's mother. A more advanced example includes speaking “motherese” to the child. This parses phonemes, thus making it easier for the child to link between a sound, graphical image and the whole word. There are many other clues from which speech understanding may be nourished, e.g. the tone of voice that helps one to link anger with the word “anger”, love and affection with the word “love” and so on.

The language acquisition method described above is primarily advantageous for use by infants and young children. However, other users may equally benefit from it. For example, all kinds of reading disorders may be treated using the method of the present invention to help teach reading. All kinds of brain damages to one of the language centers in the brain (Alzheimer, stroke, etc.) may also be treated by this method. The hearing-impaired may benefit in several aspects. For example, one of the most common reasons for late development in children is late diagnosis of hearing deficiency. By the time one is diagnosed, some damage has already being done because of insufficient language stimulation from the environment. Using the method of the present invention may help those children to better communicate with their surroundings and to reduce the damage. Children who speak two or more languages may use the method to differentiate between them, by different presentation for each language on the display device (for example English in black and French in blue letters).

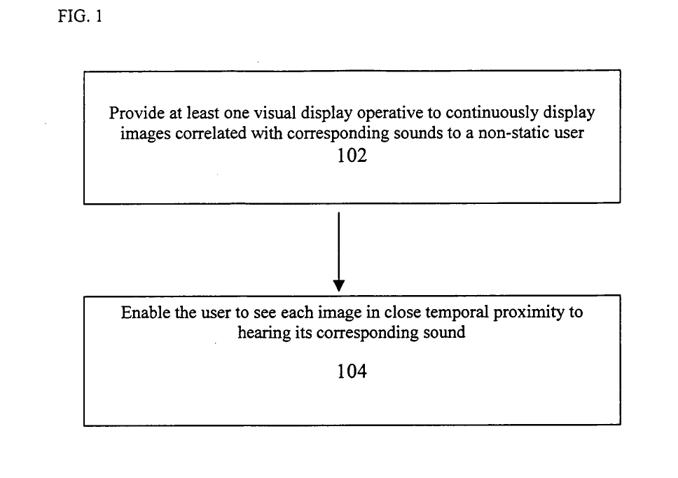

FIG. 1 shows schematically a flow chart of the language acquisition method of the present invention. The method comprises the steps of: (102) providing, in a live-learning environment, at least one visual display operative to continuously display images correlated with corresponding sounds to a non-static user and; (104) enabling the learner to see each image in close temporal proximity to hearing its corresponding sound. A “non-static” user is a user that may move at least temporarily from one spatially defined position to at least one other spatially defined position. Step 102 may be accomplished by providing a portable display device such as a portable computer or TV screen arranged to be in view of the learner at all times. The visual display is thus positioned to provide a constant line-of-sight to the user. This contrasts with prior art arrangements, in which there are times in which a user may get only one of the visual (images) or sound inputs, the other being unavailable (e.g. the display may be out of sight).

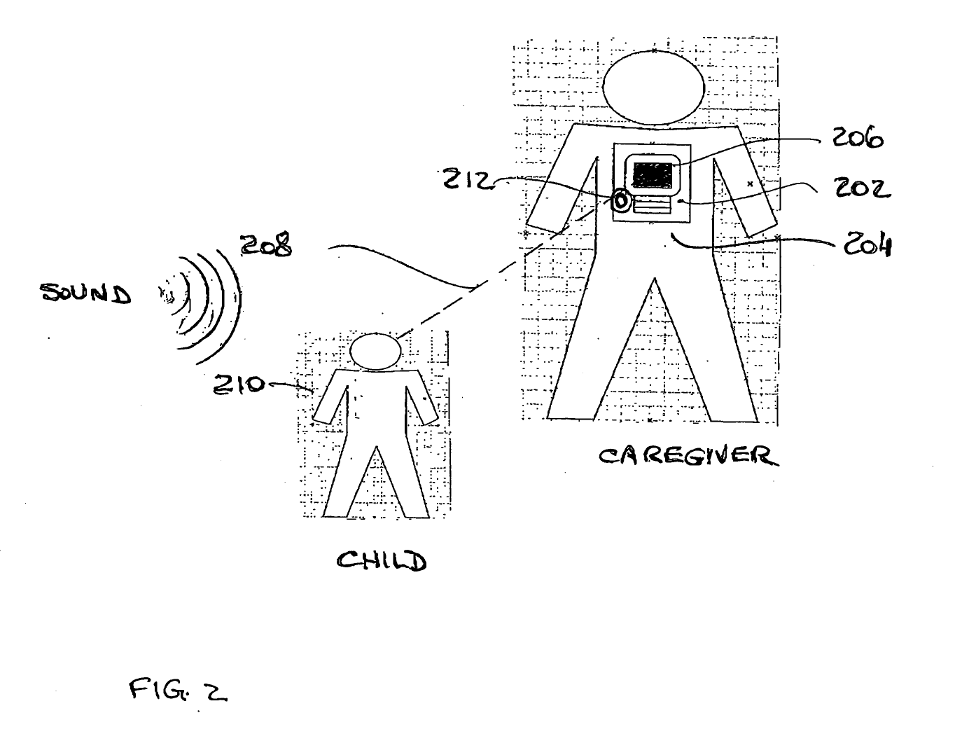

FIG. 2 shows an exemplary system embodiment in which a child learns his primary language (mother tongue). A display screen 202 is exemplarily attached to a caregiver's chest 204 and operative to display various images 206 (e.g. of various objects) visible in a line-of-sight 208 to a baby or child 210. The corresponding sound may be provided either by the caregiver, or by a system (not shown) that synchronizes the object image with its name. The caregiver naturally tends to position herself/himself so as to face the baby, e.g. when feeding it, playing with it, etc. The system may optionally be programmed to show images and emit corresponding sounds only when there exists a direct line-of-sight between caregiver and baby, e.g. by providing a miniaturized video camera 212 attached to the display, the video camera operative to detect the baby eye motion (i.e. the existence of the line-of-sight) and activate the image display and sound emission.

Since the baby is in visual contact with this person for long periods of time, this provides in effect a constant learning environment in which the baby sees images correlated with respective sounds. In another embodiment in which a grown-up person learns a secondary language, the visual display may be a miniaturized video display worn on the face (e.g. on glasses), or a miniaturized visual display system that beams the image directly to the eye. Such systems are well known in the art. In yet another embodiment, in which speech is being taught to deaf or hearing-impaired persons, the image may include details such as tone, volume and other aspects of sound analysis correlated with a sound. In this embodiment, the display may be any of the devices mentioned above and more, while the sound is originated from the hearing impaired person itself. The method thus provides live feedback to the speaking person. In yet another embodiment, the display is capable of recognizing speech and turn it into text.

In some embodiments, the sound and images may be generated by a voice-operated system. The voice-operated system may have a private name. Private naming is a method to specify a voice operated machine or electronic device in order to avoid collisions with its general name in everyday use, for example: instead of saying to a voice operated TV “TV open”, one will say “1300 open” or “Tammy open” so that it will be determined in high probability that one is addressing the object and not having a normal discussion in his environment.

In yet another embodiment, the system may be used to teach speech to hearing impaired persons. A main aim here is to provide a constant feedback to the person on his speech. The feedback is created by the person speaking and creating sounds that are translated into text displayed on the display. The displayed text may be a word different that the one he/she wanted to pronounce, in which case, the person understands that he/she pronounced to word wrongly. The system thus helps the person correct his/her pronunciation and improve his/her speech.

In one embodiment of the method as applied to reading acquisition, a mobile screen or an array of screens may be deployed in the learner's environment. In the exemplary mother-child environment, a screen may exemplarily be positioned on the parent or caregiver chest, above a bassinet, in front of a baby's booster chair in a car, in captioning glasses, etc. Alternatively, a miniaturized video screen may be incorporated in glasses. Alternatively yet, images may be beamed onto one or more surfaces (e.g. walls) in the space in which the child is present, with the corresponding sound provided in close temporal relationship or even simultaneously.

Whenever speech is heard by the learner, an automatic translation system may translate it into text and displays it on the displaying device. The learner will see the text every time speech is heard by him/her, thus linking the spoken language with the written one.

Advantageously, the method may be used constantly and regularly from the very first days of language acquisition by a child. It may accompany the learner in all stages of language acquisition, thus supporting the automatic and spontaneous linkage between the sound and its graphical representative, between words and their symbols, and decoding the data stream of the text.

In an embodiment of the present invention as applied to writing acquisition, the images displayed in step 102 include various sound analyses along with translated speech. Preferably, the display device includes captioning glasses. Optionally, an automatic feedback may be displayed to the user, thus helping hi/her understand what went wrong in a former pronunciation and try to correct it. The display device may be worn constantly or in specific oral training lessons.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for live-learning language skills comprising the steps of:
a. providing, in a live-learning environment, at least one visual display operative to display images correlated with corresponding sounds to a non-static user positioned in a line-of-sight from the at least one display; and
b. by the user, viewing each image in close temporal proximity to hearing its corresponding sound.

2. The method of claim 1, wherein the step of providing includes providing at least one visual display selected from the group consisting of a portable video display, a beamed image, a miniaturized eye-glass video display and a direct eye beamed display.

3. The method of claim 1, wherein the images include images selected from the group consisting of sentences, words, phonemes, graphemes, syllables and color images.

4. The method of claim 1, wherein the user is a child, and wherein the step of providing includes providing a display positioned on a caregiver in the line-of-sight.

5. The method of claim 1, wherein the user is a hearing impaired user pronouncing the corresponding sounds and wherein the step of providing at least one visual display operative to continuously display images correlated with corresponding sounds includes providing images selected from the group consisting of tone, volume and other aspects of sound analysis.

6. A method for live-learning language skills comprising the steps of:
a. positioning a non-static display and a non-static learner in a relational position that ensures a substantially constant spatial line-of-sight therebetween for extended periods of time; and
b. displaying an image on the display while essentially simultaneously sounding a corresponding sound that defines the image,
whereby, the positioning and sounding actions mimic a natural, live-learning environment for the acquisition of language skills.

7. The method of claim 6, wherein the non-static learner is a child, wherein the language skills include learning a primary language and wherein the step of positioning includes providing a display attached to a caregiver.

8. The method of claim 7, wherein the providing a display attached to a caregiver includes providing a display attached to a mother's chest.

9. The method of claim 6, wherein the step of displaying an image includes displaying an image selected from the group consisting of a sentence, a word, a phoneme, a grapheme, a syllable and a color image.

10. The method of claim 6, wherein the language skills include reading skills.

11. The method of claim 6, wherein the language skills include writing skills.

12. The method of claim 6, wherein the language skills include at least one secondary language.

13. The method of claim 6, wherein the non-static learner is a child, wherein the language skills include learning at least two different languages and wherein the step of positioning includes providing a display attached to a caregiver and operative to display images uniquely correlated with sounds of each language.

14. The method of claim 13, wherein the unique correlation is provided by different colors of the same image.

15. A live-learning system for acquiring language skills comprising:
a. a non-static display operative to display images correlated with corresponding sounds provided substantially simultaneously with the images; and
b. means to position the display in substantially constant line-of-sigh with a non-static user,
whereby the user acquires language skills in an environment that mimics the natural language learning environment.

16. The system of claim 15, wherein the non-static user is a child learning a primary language and wherein the means to position include a non-static display attached to a caregiver in a way that provides the substantially constant line-of-sight.

17. The system of claim 16, further comprising a detection mechanism operative to activate the display upon detection of the line-of-sight between caregiver and child.

18. The system of claim 15, wherein the non-static user is a hearing impaired user, and wherein the images are feedback sound images correlated with speech sounds pronounced by the user.

19. The system of claim 15, wherein the display is capable of recognizing speech and turn it into text.
